(19) United States
(12) Patent Application Publication
(10) Pub. No.: US 2010/0185553 A1
(43) Pub. Date: Jul. 22, 2010

(54) METHOD AND SYSTEM FOR MARKING OBJECTS

(76) Inventors: Jan-Gregor Fischer, Wifling/Worth (DE); Jörg Mandel, Stuttgart (DE)

Correspondence Address: King & Spalding LLP, 401 Congress Avenue, Suite 3200, Austin, TX, 78701, US

(21) Appl. No.: 12/676,006

(22) PCT Filed: Aug. 8, 2008
(86) PCT No.: PCT/EP2008/060462

§ 371 Date: Mar. 2, 2010

(30) Foreign Application Priority Data
Sep. 6, 2007 (DE) 10 2007 042 442.8

(51) Int. Cl. G06Q 10/00; G06F 15/18

(52) U.S. Cl. 705/348; 706/12

(57) ABSTRACT

In a method and system for marking objects which pass through different process stages, the objects are described ontologically for the respective process stages, and classes and/or relations for marking the objects as equivalents are linked to one another.

### CROSS-REFERENCE TO RELATED APPLICATIONS

This application is a U.S. National Stage Application of International Application No. PCT/EP2008/060462 filed Aug. 8, 2008, which designates the United States of America, and claims priority to German Application No. 10 2007 042 442.8 filed Sep. 6, 2007, the contents of which are hereby incorporated by reference in their entirety.

### TECHNICAL FIELD

The invention relates to a method and system for the semantic description of objects in an integrated product model to replace conventional number systems.

### BACKGROUND

An object, whether it is a material object such as a vehicle to be manufactured or a non-material service product, for example a financial service, can pass through a number of process stages of an overall process.

FIG. 1 serves to clarify the set of problems underlying the invention. A product or object passes from a process stage N to a subsequent process stage N+1. The process stage N is a supplier for example, supplying a part to be assembled to a process stage N+1 in another enterprise, where assembly of the supplied objects or supplied parts takes place. The supplied part or object is for example a pump for a motor vehicle with a certain marking.

In conventional systems different enterprises, i.e. both suppliers and purchasers or assembly enterprises use different nomenclatures for the objects. For example an article or object is marked “0001” according to the nomenclature A of the supplier enterprise, while at the assembly enterprise it is marked “000a” according to its nomenclature B. For the unique marking of a supplied article or object therefore with conventional systems the object marking is therefore transformed at the boundary between the two nomenclatures A, B.

Enterprises have one or more separate models, also referred to as phase models, for every life cycle and/or phase or process stage of a product. Object data, in particular product markings, is transformed between these phase models or process stages with different nomenclatures. An object data transformation therefore forms part of product data management within a manufacturing enterprise. Sometimes different nomenclatures are also employed within the same process stage. Where a 3D manufacturing design is being engineered for example, different software tools of the areas involved, such as logistics or assembly planning and suppliers, may have different nomenclatures.

Each phase model describes a different view of the product or article and uses different description elements. The phase model identifies and classifies products by means of different types of number systems, it being possible for changes to an identification, classification or structuring in one phase model to have a direct impact on other phase models.

Products or articles from external suppliers can be identified without further ado from the number system of the supplier company. From the point of view of the purchaser or the enterprise assembling the individual parts integration into its own number system is essential. In a conventional system this transformation between two number systems can take place by means of corresponding, manually generated transformation tables. A transformation between an internal numbering system and an external numbering system and changes to the master and structure data in the supplier network represent a considerable constant adjustment outlay for the enterprise. There is also always the risk of lack of data integrity and lack of consistency with regard to product data.

In many enterprises different nomenclatures or number systems are even used for different areas of the enterprise. For example an object or product is given a different designation in the design department from the one used in manufacture or quality assurance. With conventional systems it is therefore also necessary often to carry out a transformation between nomenclatures of different areas of the enterprise.

Conventional systems also have the disadvantage that they are inflexible in respect of changes to number systems. If a supplier changes its nomenclature or number system for example, it is necessary to implement corresponding transformations to add to or change all the process stages.

FIG. 2 shows a conventional hierarchically structured system for identifying and classifying products or articles with so-called subject feature lines. A class “pump” has two subclasses “piston pump” and “sine pump”, which in turn have their own subclasses. For example the subclass “piston pump” for its part has the subclass “piston pump steel” and the subclass “piston pump brass”. Within the subclasses a component list shows uniquely identifiable objects; for example the subclass “piston pump steel” contains an object with the article code “0170101001” with the name KPS7710-X12. This object has as its characteristics a height H of 12, a length L of 60 and a weight of W=32.8. The conventional product marking shown in FIG. 2 is based for example on a supplier nomenclature. If the supplier supplies pumps to a purchaser, for example a vehicle manufacturer, said vehicle manufacturer is forced to translate or transform the component lists to its own nomenclature when the articles are supplied. If the supplier changes nomenclature or adds other pumps to its range, the purchaser or vehicle manufacturer must add to its nomenclature accordingly. As can be seen from the example illustrated in FIG. 2, a complex product like a vehicle has a number of incorporated articles or supplied parts, so any adjustments or changes to the transformations between the different marking systems represents a considerable outlay for the enterprise. The situation is also exacerbated, when a purchaser obtains supplied parts from a large number of different supplier enterprises, each having their own number system. If a purchaser wants to buy corresponding supplied parts from a different supplier offering supplied parts with more favorable delivery conditions, the purchaser is also forced first to adjust its number system, in which process they have to define transformations from the number system of the new supplier to its own number system. The outlay required for this makes it more difficult for the purchase to change from an old supplier to a different one.

### SUMMARY

According to various embodiments, a method and system for marking objects can be created, with which no transformations are required between different nomenclatures of different process stages.

According to an embodiment, in a method for marking objects, which pass through different process stages, the objects are described ontologically for the respective process stages and classes and/or relations for marking the objects as equivalents are linked to one another.

According to a further embodiment, the objects can be described in the ontology language OWL (Web Ontology Language). According to a further embodiment, process stages may have process phases, each having an associated nomenclature. According to a further embodiment, each process stage may have its own nomenclature. According to a further embodiment, an object can be a material object or a non-material service product. According to a further embodiment, a number of process stages may form a process domain. According to a further embodiment, standard classes and standard relations can be provided within the process domain. According to a further embodiment, standard classes and standard relations of one process stage of a process domain can be linked automatically to corresponding standard classes and standard relations of another process stage of the process domain. According to a further embodiment, classes and relations of a process stage can be automatically linked by means of predetermined rules. According to a further embodiment, the rules used can be generated automatically by learning methods. According to a further embodiment, the rules used can be instantiated automatically based on predetermined templates for generating rules. According to a further embodiment, object markings can also be allocated to the objects marked by linking.

According to another embodiment, in a system for marking objects, which pass through different process stages, the objects are described ontologically for the respective process stages and classes and/or relations for marking the objects as equivalents are linked to one another.

### BRIEF DESCRIPTION OF THE DRAWINGS

Embodiments of the method and the system are described below with respect to various figures. In the drawings:

FIG. 1 shows a conventional system with different nomenclatures to illustrate the set of problems underlying the invention;

FIG. 2 shows a conventional marking system;

FIG. 3 shows a diagram illustrating the mode of operation of the method for marking objects according to an embodiment;

FIG. 4 shows an example relating to the ontological description of different process stages to explain the mode of operation of the method according to an embodiment;

FIG. 5 shows an example of a mapping between ontological object descriptions of different process stages to explain the method according to an embodiment;

FIG. 6 shows an example of a relation, as used in the method according to an embodiment;

FIG. 7 shows an example of an entity for the example cited in FIG. 4.

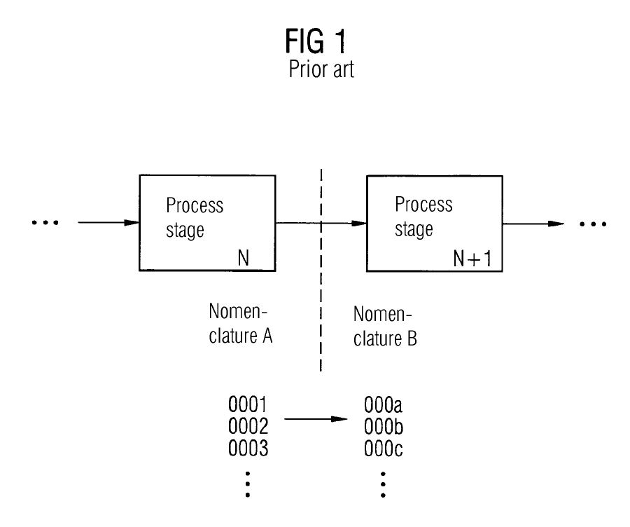

### DETAILED DESCRIPTION

According to various embodiments, a method for marking objects which pass through different process stages can be created, the objects being described ontologically for the respective process stages and classes and/or relations for marking the objects as equivalents being linked to one another.

In one embodiment of the method the objects are described in the ontology description language OWL (Web Ontology Language).

In one embodiment of the method a process stage consists of one or more sequential or parallel process phases, each having an associated nomenclature.

In one embodiment of the method each process stage has its own name space or nomenclature.

In one embodiment of the method an object is a material object or a non-material service product.

In one embodiment of the method a number of processes stages form a process domain.

In one embodiment of the method standard classes and standard relations are provided within a process domain.

In one embodiment of the method standard classes and standard relations of one process stage within a process domain are linked automatically with corresponding standard classes and standard relations of another process stage of the process domain.

In one embodiment of the method classes and/or relations of a process stage are linked to one another automatically by means of predetermined rules.

In one embodiment the rules used are generated automatically by learning methods.

In a further embodiment the rules used are instantiated automatically using predetermined templates for generating rules, known as rule templates.

In one embodiment of the method object markings are also allocated to the objects marked by linking.

According to other embodiments, in a system for marking objects which pass through different process stages, the objects being described ontologically for the respective process stages and classes and/or relations for marking the objects as equivalents being linked to one another.

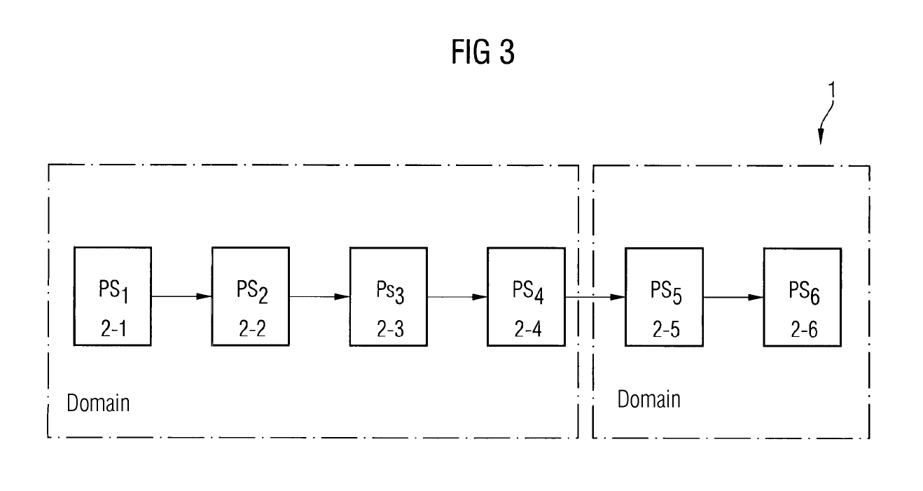

As can be seen from FIG. 3 a system 1 according to various embodiments for marking objects has a number of process stages, which the objects pass through. In the example illustrated in FIG. 3 objects pass sequentially through a number of process stages 2-1 to 2-4 of a first domain before they pass through two process stages 2-5 to 2-6 of a second domain. A number of process stages form a so-called process domain. The process stages can be any process stages, for example process stages of a manufacturing process or a financial process. In the example illustrated in FIG. 3 the process stage 2-1 is for example a process stage for designing a complex object, for example a vehicle. The stage 2-2 is formed by a manufacture preparation stage and the process stage 2-3 by an assembly stage for assembling the product. The process stage 2-4 for example represents a stage for quality assurance for the vehicle. In the example shown in FIG. 3 the process stages 2 are connected to one another in a serial manner. In alternative embodiments the process stages can also be linked to one another in any manner.

With the method for marking objects according to various embodiments, the objects for the respective process stages 2 are described ontologically. For example the objects are described ontologically using the Web Ontology Language (OWL). Ontology is a knowledge base, in which information for or about the object is stored by a network of relationships, for example classes, subclasses, relations as well as characteristics or attributes. The ontology includes structured and organized concepts and allocations, which describe a product in individual process stages of a product cycle. Products are instantiated in the ontological model at their manufacturing time. The connection of an actual product to the representation of the product as an object in a modeled product class is effected by instantiation of the class.

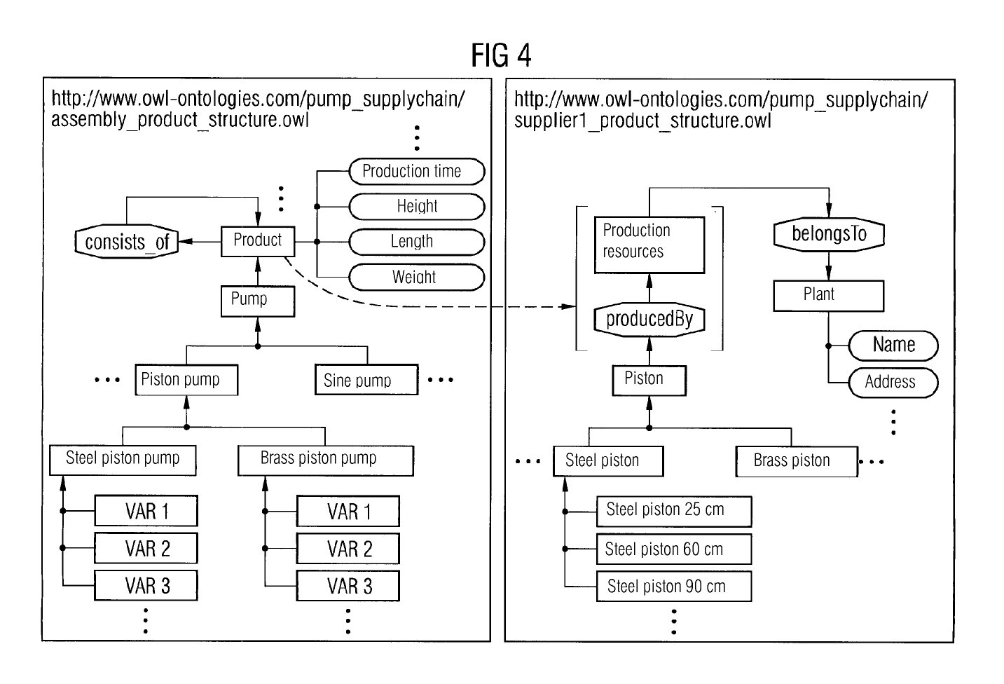

FIG. 4 shows an example of an ontological description of objects in two process stages to explain the method according to various embodiments. The example illustrated shows a process stage of a pump supplier and of an assembly enterprise, in which pumps are incorporated in a complex product.

As can be seen in FIG. 4, a class “Product” is defined with the characteristics or attributes “production time”, “height”, “length”, “weight”. The relation “consists of” allows a product to consist of a single product or a number of products. The class “Product” has as a subclass the class “pump”, the characteristics or attributes of the class “Product” being handed down to this subclass “Pump”. The subclass “Pump” in turn has two subclasses “Piston Pump” and “Sine Pump”, which also inherit the characteristics or attributes of the higher class “Product”. The subclass “Piston Pump” in turn has two subclasses “Piston Pump Steel” and “Piston Pump Brass”, with variants VAR1, VAR2, VAR3 in turn being present for each subclass. All the direct subclasses of “Product” and those declared indirectly by way of the transitivity characteristic of the inheritance relation inherit the relations and characteristics from “Product”.

The supplier describes the products it produces. In the example shown the supplier produces pistons for a pump. Here the class “Piston” has subclasses, namely “Piston Steel” and “Piston Brass”. There are also different variants of steel pistons of different length, namely “Piston Steel 25 cm”, “Piston Steel 60 cm” and “Piston Steel 90 cm”. The class “Piston” is related to the class “Production Resource” by a relation “producedBy”, which indicates that the class “Production Resource” is related in a binary manner to the class “Piston”. A further binary relation indicates that the class “Production Resource” is associated by way of the “belongsTo” relation to a plant (class “plant”) with the characteristics Name and Address or is produced there.

Both process stages, namely the process stage of the supplier “Supplier 1” and the assembly process stage “assembly” in the cited example are described ontologically in OWL language in a so-called T-box, each process stage having its own name space, for example “ASS” for assembly and “SUPP1” for the supplier.

With the method according to various embodiments, classes and/or relations of the ontological description are linked to one another as equivalents to mark objects.

In the example illustrated in FIG. 4 the class “Product” is defined within the ontological description of the assembly process stage as equivalent to the class of individuals produced by the class “Production Resource”.

In the method according to various embodiments, unique identification of an object does not take place as with conventional methods based on an assigned object ID or object name but based on the semantic/ontological description of the object in different process stages, which are linked to one another.

FIG. 5 shows an example of a mapping between two ontological product descriptions for the two process stages illustrated in FIG. 4. The OWL description language is based on XML. Two different name spaces XMLNS are defined for the two different process stages. The class “Product” in the assembly process stage is defined as equivalent to the class of those individuals produced by the class “Production Resource” in the process stage of the supplier. This ontology mapping is used to link together the ontologies of the different process stages, which are associated for example with different companies or parts of a company. For the unique identification of entities informative relations or characteristics are selected, which restrict the result space of the identification process sufficiently. For example a product can be uniquely identified by indicating the product class, product variant, production site, i.e. precise details of the location of a manufacturing resource and a production time and in some circumstances by indicating the product structure. For example a certain pump or entity of the class “Piston Pump Steel” can be individualized uniquely based on the inherited characteristics of the higher class “Product” and classes or relations linked thereto.

For example a certain piston pump made of steel (“Piston Pump Steel”) can be individualized uniquely based on the inherited attributes or characteristics of the higher class “Product” and linked classes or relations. A certain piston pump made of steel is produced for example at a certain production time, having a certain height, a certain length and a certain weight, the produced or manufactured piston pump being manufactured by a certain production resource of the supplier within a certain plant of the supplier. For example a piston pump made of steel (piston pump steel) is produced on May 10, 2007 at 14:53 hrs and 30 seconds having a height H=12, a length L=60 and a weight W=32.8, by a production resource of a certain supplier (supplier 1), associated with a production plant (plant) with a certain name, for example “Bremen_Plant”. The more attributes or characteristics there are associated with the class to be instantiated, the more uniquely an individual object can be identified. A further possibility for facilitating individualization is to use attributes or characteristics, which provide a value range with a particularly high resolution, for example a production time with a high temporal resolution. A manufactured object is individualized uniquely for example for a defined manufacturing rate of 1 object per millisecond with a resolution of 1 millisecond for the manufacturing time. So-called reasoners can also be used to verify both the consistency and characteristics of the process stages extensively and for terminology and entity data enquiries.

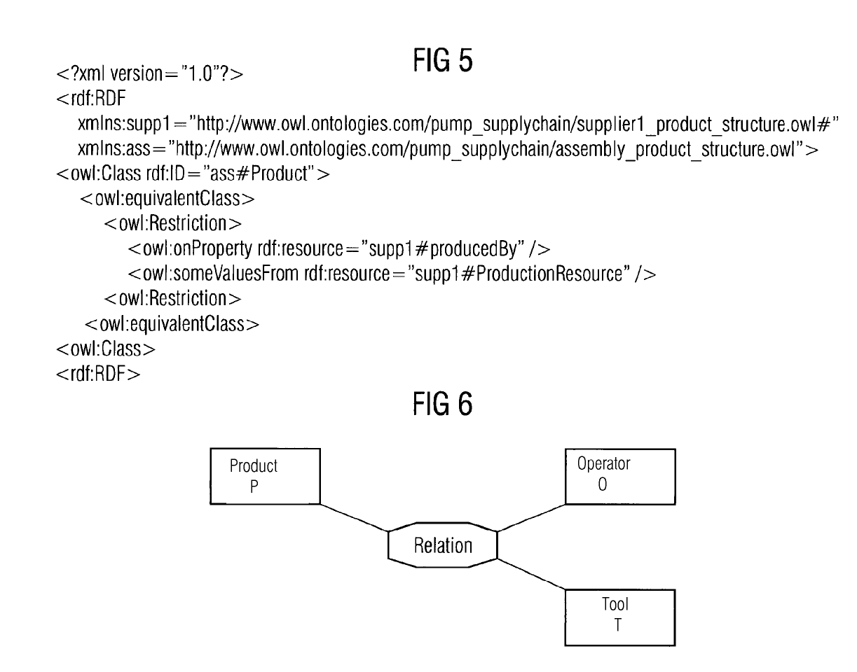

FIG. 6 shows an example of a relation within an ontological description of a process stage. A relation can link a number of classes to one another. A relation can connect two classes to one another for example as a binary relation or three classes as a ternary relation. FIG. 5 by way of example shows a ternary relation, which links three classes logically to one another, namely the class “Product P”, the class “Operator O” and the class “Tool T”. The relation can be for example as follows: The product P is manufactured by the operator O using a tool T.

A binary relation links two classes to one another. A characteristic of one class can be considered to be a unary relation, i.e. the relation only applies with this class.

In one embodiment of the method a number of process stages form a so-called process domain, for example a number of stages within an enterprise. However a process domain can for example also comprise all the process stages within a sector, for example within the automotive industry.

In one possible embodiment standard classes and standard relations can be defined or provided within a process domain. In one possible embodiment a standard class or standard relation in one process stage of the process domain can be linked automatically to a corresponding standard class or standard relation of another process stage of the same process domain.

In the exemplary embodiment shown in FIG. 4 it is possible to define the class “Production Resource” and the relation “producedBy” as standard elements, which are always to be linked to the standard class “Product” in an equivalent relationship. Specifying standard classes and standard relations, which are linked to one another by predetermined rules, allows objects to be marked automatically based on the ontological relationship network.

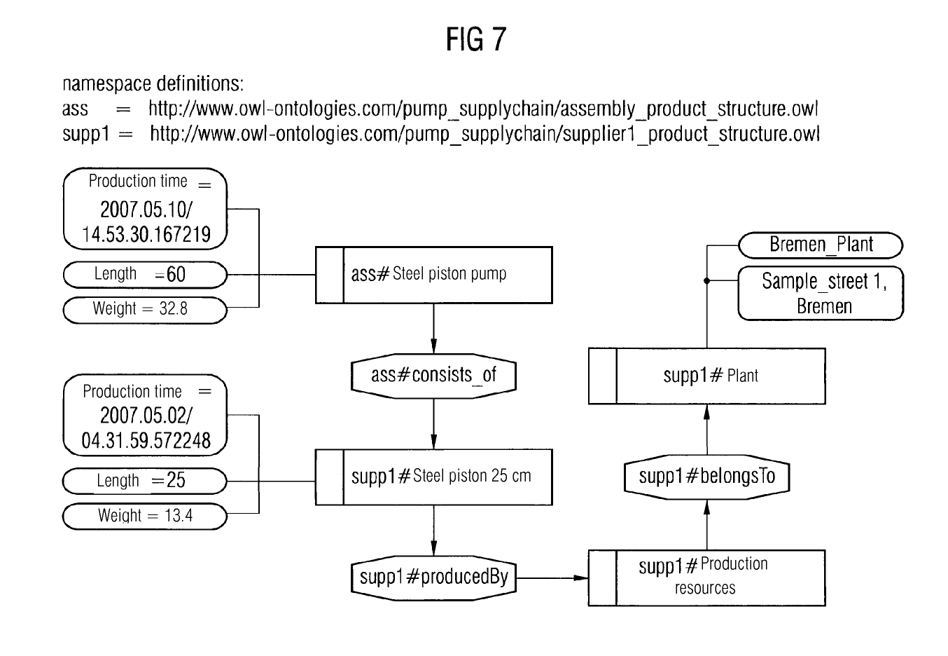

FIG. 7 shows an example of an instantiation of the ontological description model illustrated in FIG. 4. An entity or individual, which does not itself have to be provided with an object ID, is individualized uniquely by its relationship network, in particular based on the inherited characteristics and the link to the manufacturing process of the supplier. In the example illustrated in FIG. 7 the entity or individual object is marked uniquely by a precise production time, namely Oct. 5, 2007 at 14:53 hrs and 30 seconds, a length of 60 and a weight of 32.8 and the relationship, established by an equivalence link, to the ontological description of a steel piston (“Piston Steel 25 cm”) of the supplier 1 (SUPP1) incorporated therein. In the illustrated example the individual pump is individualized uniquely, in addition to the characteristics of the higher class “Product”, which are handed down to the subclass “Piston Pump Steel”, by the linking of the ontological descriptions of the two process stages and also data for the entity or individual product. As can be seen from FIG. 7, the steel piston contained in the pump has a length of 25 cm. The steel piston was produced by the supplier, with production of the steel piston taking place by means of an entity of a production resource (“Production Resource”), associated with a plant of the supplier SUPP1 in Bremen. The steel piston was manufactured at an individual production time, namely Feb. 5, 2007 at 4:31:59 hrs, the steel piston having a length of 25 cm and a weight of 13.4.

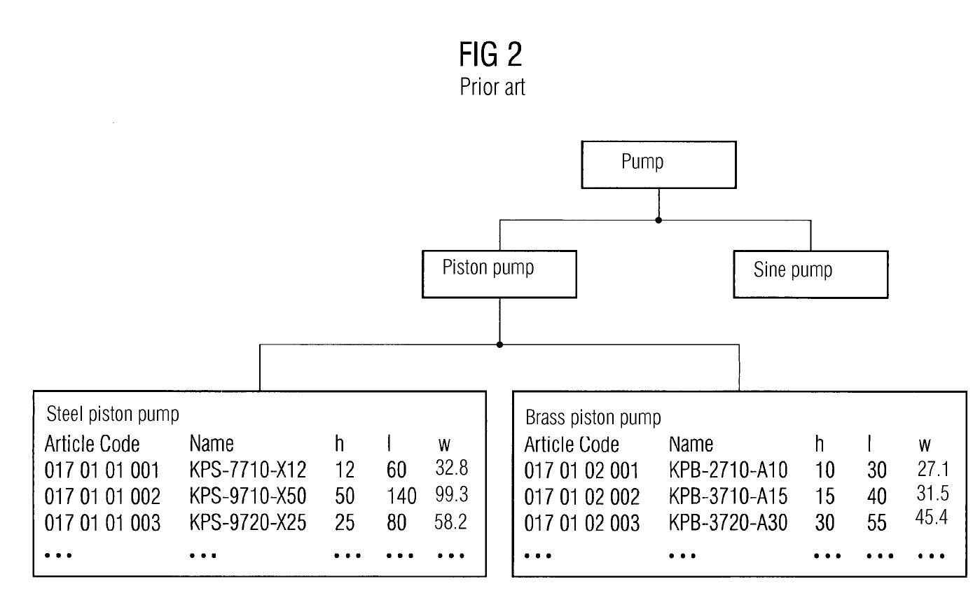

With the method according to various embodiments therefore a certain produced piston pump (piston pump steel) is not provided, as with conventional methods, with an object identification, for example an article code or name, but is individualized uniquely by an ontological relationship network, which extends over a number of process stages. With the conventional method, as illustrated in FIG. 2, a piston pump made of steel (piston pump Steel) is marked for example by the object identification (Article code=0170101001) with the name “KPS-77-10-X12”. In contrast, with the method according to various embodiments a piston pump made of steel is individualized by an entity of an ontological relationship network, as illustrated by way of example in FIG. 7. In one possible embodiment the entity can be assigned a further marking, which is easy for a user to understand for example. For example the entity or object marked uniquely in FIG. 7 by the ontological relationship network can also be provided with a name, for example “Piston pump steel HANS”.

With the method according to various embodiments an object, for example a manufactured product, can be identified regardless of whether it has passed through the manufacturing process, is present in a warehouse as a part on a component list, is incorporated in a module from an external company or comes up in analyses. With the system according to various embodiments numbering and name marking are not required. With the method according to various embodiments the objects are individualized or marked implicitly by characteristics and relations. Thus with the method according to various embodiments the transformation of different nomenclatures is not required. The method or system according to various embodiments is characterized by a high level of flexibility and unlimited extendability. The method and system according to various embodiments can be integrated into a product management system. The introduction of ontology-based models means that the number systems of conventional systems are superfluous. It is possible here to classify both master data and structure data semantically with the aid of a terminology tailored to the process stages.

The method and system according to various embodiments are suitable for any objects or products, i.e. both for material products and also for service products.

What is claimed is:

1. A method for marking objects, which pass through different process stages, the method comprising the step of: objects ontologically for the respective process stages and at least one of classes and relations for marking the objects as equivalents linked to one another.

2. The method according to claim 1, wherein the objects are described in the Web ontology language (OWL).

3. The method according to claim 1, wherein process stages have process phases, each having an associated nomenclature.

4. The method according to claim 1, wherein each process stage has its own nomenclature.

5. The method according to claim 1, wherein an object is a material object or a non-material service product.

6. The method according to claim 1, wherein a number of process stages form a process domain.

7. The method according to claim 6, wherein standard classes and standard relations are provided within the process domain.

8. The method according to claim 7, wherein standard classes and standard relations of one process stage of a process domain are linked automatically to corresponding standard classes and standard relations of another process stage of the process domain.

9. The method according to claim 1, wherein classes and relations of a process stage are automatically linked by means of predetermined rules.

10. The method according to claim 9, wherein the rules used are generated automatically by learning methods.

11. The method according to claim 9, wherein the rules used are instantiated automatically based on predetermined templates for generating rules.

12. The method according to claim 1, wherein object markings are also allocated to the objects marked by linking.

13. A system for marking objects comprising a plurality of different stages through which said objects pass, wherein the system id operable to describe the objects ontologically for the respective process stages and is further operable to link at least one of classes and relations for marking the objects as equivalents one another.

14. A method for marking objects, comprising the steps of:
marking objects ontologically for respective process stages wherein at least one of classes and relations for marking the objects as equivalents are linked to one another, and
passing a marked object from a first process stages to a following process stage.

15. The method according to claim 14, wherein the objects are described in the Web ontology language (OWL).

16. The method according to claim 14, wherein process stages have process phases, each having an associated nomenclature.

17. The method according to claim 14, wherein each process stage has its own nomenclature.

18. The method according to claim 14, wherein an object is a material object or a non-material service product.

19. The method according to claim 14, wherein a number of process stages form a process domain.

20. The method according to claim 19, wherein standard classes and standard relations are provided within the process domain.
